(19) United States
(12) Patent Application Publication
(10) Pub. No.: US 2006/0088640 A1
(43) Pub. Date: Apr. 27, 2006

(54) Peanut flour cracker

(75) Inventors: Susan Kay McWatters, Fayetteville, GA (US); Sue Ellen McCullough, Griffin, GA (US); Sandra L. Walker, Griffin, GA (US)

Correspondence Address: Homer W. Faucett, III;ICE MILLER, One American Square, Box 82001, Indianapolis, IN, 46282-0200, US

(73) Assignee: University of Georgia Research Foundation, Inc., Athens, GA (US)

(21) Appl. No.: 11/215,427

(22) Filed: Aug. 30, 2005

Related U.S. Application Data
(60) Provisional application No. 60/620,846, filed on Oct. 21, 2004.

(51) Int. Cl. A21D 10/00

(52) U.S. Cl. 426/549

(57) ABSTRACT

Methods and compositions for baked food products are provided. Illustrative baked food products comprise a flour mixture comprising peanut flour, baking powder, a fat, a milk product, and egg. Illustrative methods comprise preparing a dough comprising wheat flour, salt, baking powder, a fat, a milk product, egg, and peanut flour, rolling the dough, and baking the dough.

This application claims priority to U.S. Provisional Application No. 60/620,846, filed Oct. 21, 2004, herein incorporated by reference in its entirety.

### BACKGROUND OF THE INVENTION

The present invention is directed to baked food products comprising peanut flour, and is illustratively directed to crackers made with peanut flour.

Previous work (Zenere, “Physicochemical and Sensory Properties of a Chip-type Snack Food Based on Defatted Peanut and Soy Flour,” Ph.D. Dissertation, University of Georgia, 2003) showed that baked peanut chips could be processed from partially defatted flour milled from cold-pressed peanuts (with testa). However, because of the composition of the flour (40-44% protein, 10-14% fat) and high level of usage (greater than 50% of total ingredients in some formulations), some of the baked products were undesirably hard and tended to pack in the teeth when chewed. Initial sensory evaluation tests showed potentially high consumer acceptance of such a snack food, particularly if the texture could be made softer and more cracker-like.

### SUMMARY OF THE INVENTION

Baked products have been developed by incorporating peanut flour in the recipe. In one aspect of this invention, a baked food product is provided comprising a flour mixture comprising peanut flour, baking powder, a fat, a milk product, and egg. Illustratively, the peanut flour is light roast peanut flour that has been partially defatted to 10 to 14%, and the milk product is selected from the group consisting of whole milk, reduced fat milk, and non-fat dry milk, and the fat is butter, margarine, vegetable oil, hydrogenated vegetable oil, partially hydrogenated vegetable oil, and/or vegetable shortening. If non-fat dry milk is used, water may be added. In another illustrative embodiment, the flour mixture comprises peanut flour, wheat flour, and rice flour. Additionally, one or more seasonings may be added. Illustratively, the baked food product has the shape and texture of a cracker.

In another aspect of this invention, methods of preparing a baked food product are provided, comprising the steps of preparing a dough comprising wheat flour, salt, baking powder, a fat, a milk product, egg, and peanut flour; rolling the dough; and baking the dough. Optionally, the dough is cut into cracker size prior to the baking step. The baking step optionally includes baking in an impingement oven, baking at 200° C., and/or baking for a sufficient time period to obtain a generally uniform crispy texture.

Additional features of the present invention will become apparent to those skilled in the art upon consideration of the following detailed description of preferred embodiments exemplifying the best mode of carrying out the invention as presently perceived.

### DETAILED DESCRIPTION

Various compositions were used in developing a peanut flour cracker. Commercial light roast peanut flour with 50% protein and 12% fat was used in a basic cracker formula (wheat flour, shortening, egg, milk, baking powder, salt) at levels ranging from 7 to 42%, with and without rice flour. While vegetable shortening is used, it is understood that other fats such as butter, margarine, vegetable oil, hydrogenated vegetable oil, and partially hydrogenated vegetable oil may be used instead. Also, while whole milk is used in the illustrative examples, it is understood that reduced fat milk, evaporated milk, or dry milk may be used instead, and water content adjusted accordingly. Ten illustrative flour mixtures based on a three-component (wheat, rice, peanut) constrained simplex lattice design were investigated. Process conditions (mixing, sheeting, cutting, baking) were established in preliminary trials. All 10 formulas had instrumental color and texture measurements that fell within the range of values determined for five commercial crackers (Saltines, Munchems, Wheatables, Wheatsworth, Wheat Thins). All of the illustrative crackers contained more nitrogen (1.74 to 3.87%) and thus more protein than the commercial crackers (1.24 to 1.68% nitrogen). Not surprisingly, formulas #3 and #10 which contained the highest levels of peanut flour (42 and 30.33%, respectively) had the highest nitrogen content (3.87 and 3.15%, respectively). The flour mixture with the highest level of peanut flour that also exhibited the best overall dough handling characteristics was formula #6 (58% wheat, 17.5% rice, 24.5% peanut). This mixture was then used as a control for further development to incorporate seasonings that could enhance the flavor of the basic cracker. The flavor variations and levels of use were: garlic powder, 2%; Cajun salt, 2.4%; cheddar cheese, 10.5% and cheddar cheese/cayenne, 10.4%. All variations and the control were formulated to contain 1% salt. Consumers (n=75) recruited from the local community (Griffin, Ga.) evaluated the sensory quality of the crackers. Crackers made with cheddar cheese or cheddar cheese/cayenne pepper received the highest hedonic ratings (9-point scale) for appearance (7.0=like moderately), color (7.1-7.2), aroma (6.3-6.5=like slightly), flavor (6.4-6.5), texture (6.6-6.7) and overall liking (6.4-6.7). Consumers (67%) were concerned about the nutritional quality of the crackers they consumed and 71% were willing to pay more for crackers with enhanced nutritional quality. These findings indicate that processing of a peanut flour chip or cracker that is acceptable to consumers is feasible and has potential for expanding the use of peanuts.

### EXAMPLE I

### Peanut Flour Cracker Formulations

Commercial testa-free, partially defatted peanut flour (50% protein, 12% fat) obtained from Golden Peanut Co., Alpharetta, Ga., was used in each of the formulations. Light, medium, and dark-roast flours were evaluated in preliminary trials to select the flour with the most desirable peanut flavor intensity after baking. Medium and dark roast flours produced crackers that had over roasted, bitter flavors. Therefore, only light roast peanut flour was used for subsequent baking trials. A food processor (GE 4-speed, model 106622F, Wal-Mart, Bentonville, Ark.) was used to mix and knead the dough ingredients under controlled conditions of time and speed. Two-stage sheeting (Anets SDR-4 dough roller, Anetsberger Brothers, Northbrook, Ill.) to reduce the dough to a uniform thickness was employed. Crackers were cut with a standard strip cutter (Moline Machinery, Duluth, Minn.). Preliminary baking trials found that impingement oven baking at 200° C. for 3 minutes produced uniformly baked crackers. A three component (wheat, rice, peanut flours) constrained simplex lattice design (Table 1) was used to evaluate the cracker-making performance of flour mixtures and to identify mixtures that had acceptable dough handling as well as desirable end product characteristics. It is understood that peanut flour does not contain sufficient quantities of gluten. Therefore, wheat flour is illustratively added to the flour mixture. Rice flour is added in several of the illustrative examples. It is understood that other types flour may be added as well. Objective quality measurements (color, texture, proximate composition) were determined on 10 illustrative formulations plus 5 types of commercial crackers. Consumer acceptability of the most promising formulations was also determined.

TABLE 1
Composition of peanut flour cracker formulations in a three-component
constrained simplex-lattice mixture design

| | Ingredient (%) | | |
|---|---|---|---|
| Formula | wheat flour (X1) | rice flour (X2) | peanut flour (X3) |
| 1 | 93.00 | 0.00 | 7.00 |
| 2 | 58.00 | 35.00 | 7.00 |
| 3 | 58.00 | 0.00 | 42.00 |
| 4 | 75.50 | 17.50 | 7.00 |
| 5 | 75.50 | 0.00 | 24.50 |
| 6 | 58.00 | 17.50 | 24.50 |
| 7 | 69.67 | 11.67 | 18.67 |
| 8 | 81.33 | 5.83 | 12.83 |
| 9 | 63.83 | 23.33 | 12.83 |
| 10 | 63.83 | 5.83 | 30.33 |

### EXAMPLE III

### Dough Handling Characteristics

Dough handling characteristics of 10 illustrative cracker formulations plus 100% control were evaluated. The results are summarized in Table 2. Three mixtures (#1, #2 and #6) produced doughs that were easy to handle (roll, cut and sheet). Two mixtures (#3, #9) did not form a dough ball and required manual shaping. Sticky or crumbly doughs that were difficult to handle were produced by formulas #4, #9 and #10. Formulas #5, #7 and #10 were difficult to transfer after cutting to the baking pan.

TABLE 2
Dough handling characteristics of peanut flour crackers

| Formula | Characteristic |
|---|---|
| 1 | Easy |
| 2 | Easy |
| 3 | Some difficulty, would not make dough ball, made |
| | small beads, required manual shaping of ball |
| 4 | Easy, but slightly sticky dough |
| 5 | Difficult to transfer cut dough to baking pan |
| 6 | Easy |
| 7 | Made a soft dough, fragile, difficult to transfer cut |
| | dough to baking pan |
| 8 | Slightly soft dough, all crackers separated at cut line |
| | after baking |
| 9 | Some difficulty, dough was sticky and moist, required |
| | manual shaping of ball |
| 10 | Some difficulty, dough was slightly crumbly, difficult |
| | to transfer cut dough to baking pan |
| 100% wheat flour | Did not handle well, had to be mixed twice, |
| | stuck to paper |

### EXAMPLE III

### Color Measurements

Color measurements (L*=lightness, a*=redness to greenness, b*=yellowness to blueness) were determined in triplicate using a Gardner Colorimeter XL845 (Pacific Scientific, Bethesda, MD) calibrated with a standard reference tile (L*=82.57, a*=−2.01 and b*=27.87). Psychometric color terms of chroma [(a*²+b*²)^{1/2}], hue angle [tan⁻¹(b*/a*)] and total color difference, ΔE [(L*−L* reference)²+(a*−a* reference)²+(b*−b* reference)²]^{1/2} were computed for all samples.

Instrumental measurements of the color of the crackers are shown in Table 3. For commercial crackers, the degree of lightness (L*) ranged from 66.6 to 84.3 on a scale of 0 (black) to 100 (white); degree of redness (a*) ranged from 0.01 to 7.0 and yellowness (b*) from 23.0 to 30.1. Control crackers (100% wheat flour) had the highest value for L* (81.2) and the lowest for redness (a*=0.8) and yellowness (b*=24.9) compared to the illustrative crackers. Crackers made from formula #3 contained the highest level of peanut flour (42%) and were darker (lowest L*=70.9), more red (a*=6.1) and more yellow (b*=33.2) compared to 100% wheat flour crackers and the other 9 illustrative crackers. Although there was variation in color among illustrative formulations, color values of crackers containing mixtures of wheat, rice, and peanut flours fell within the color range of the commercial crackers.

TABLE 3
Color characteristics of crackers containing wheat, rice and peanut flours,
100% wheat (control) and selected commercial crackers^{a}

| Formula^{b} | L* | a* | b* | chroma | hue angle | ΔE |
|---|---|---|---|---|---|---|
| 1 | 78.9a | 2.3e | 27.2f | 27.4e | 85.2a | 5.2h |
| 2 | 76.8c | 2.8de | 28.9e | 29.1d | 84.4ab | 7.1gf |
| 3 | 70.9h | 6.1a | 33.2a | 33.8a | 79.6d | 14.5a |
| 4 | 77.8b | 2.7de | 27.4f | 27.5e | 84.4ab | 6.3g |
| 5 | 73.9f | 4.7b | 30.2cd | 30.5c | 81.2c | 10.6c |
| 6 | 73.5fg | 4.9b | 31.1b | 31.5b | 81.0c | 11.2bc |
| 7 | 74.8e | 3.5c | 30.4bc | 30.6c | 83.5b | 9.2d |
| 8 | 76.1cd | 2.7de | 29.4de | 29.5d | 84.8ab | 7.5ef |
| 9 | 75.7d | 3.1cd | 29.6de | 29.8d | 84.0ab | 8.2e |
| 10 | 72.8g | 4.8b | 31.2b | 31.6b | 81.3c | 11.7b |
| Control | 81.2b | 0.8d | 24.9e | 24.9e | 88.3a | 4.6f |
| (100% wheat) | | | | | | |
| Saltines | 84.3a | 0.01d | 23.0f | 23.0f | 90.0a | 5.5e |
| Munchems | 78.8c | 4.8b | 34.8a | 35.1a | 82.2b | 9.3d |
| Wheatables | 66.6f | 7.0a | 30.1b | 30.9b | 76.9d | 18.4a |
| Wheatsworth | 70.3e | 3.7c | 29.0c | 29.2c | 82.7b | 13.6b |
| Wheat Thins | 72.9d | 5.0b | 26.5d | 27.0d | 79.3c | 11.8c |

^{a}Mean values in the same column for each group not followed by the same letter are significantly different (p ≦ 0.05). Color measurements were made with a Gardner Colorimeter XL845, Pacific Scientific, Bethesda, MD.
L* = lightness (0 = black, 100 = white).
Color measures of chroma (a*² + b*²)^{1/2} and hue angle [tan⁻¹(b*/a*)] were calculated from + a*(redness) and + b*(yellowness) values.
ΔE (total color difference) = [(L* − L* reference)² + (a* − a* reference)² + (b* − b* reference)² ]^{1/2}.
^{b}Formula numbers correspond to the numbers shown in Table 1.

### EXAMPLE IV

### Texture

The textural quality of the crackers was evaluated in triplicate using the Instron universal testing machine (model 1122, Instron Corp., Canton, Mass.) equipped with a Kramer cell attached to a 500 kg load cell. Maximum force (N) and energy (J) required to crush ˜10 grams (5 crackers) were calculated from the force-deformation curve.

Instrumental measures of the texture of the crackers are shown in Table 4. The amount of force required to crush the commercial crackers ranged from 1870.8 to 4108.3 Newtons (N); the amount of energy ranged from 8.6 to 18.7 Joules (J). Control crackers (100% wheat flour) required 2394 N and 6.8 J to crush. Force values for the illustrative crackers ranged from 2000.3 to 2735.2 N and were within the range found for commercial crackers. Energy values for the illustrative crackers ranged from 4.8 to 10.7 J. Young's modulus, a measure of elasticity, ranged from 157.8 to 421.8 Mpa for the illustrative crackers and from 148.0 to 386.4 Mpa for commercial crackers. Overall, illustrative crackers had similar textural characteristics to those of commercial crackers.

TABLE 4
Texture characteristics of crackers containing wheat, rice and peanut
flours, 100% wheat (control) and selected commercial crackers^{a}

| | | | Young's modulus |
|---|---|---|---|
| Formula^{b} | peak force (N) | energy (J) | of elasticity (Mpa) |
| 1 | 2159.2bc | 5.3a | 285.6b |
| 2 | 2029.3c | 4.8a | 310.7ab |
| 3 | 2169.9bc | 5.8a | 277.1bc |
| 4 | 2173.2bc | 10.7a | 157.8c |
| 5 | 2735.2a | 6.8a | 421.8a |
| 6 | 2291.8abc | 5.7a | 302.4ab |
| 7 | 2483.8abc | 6.7a | 305.5ab |
| 8 | 2686.6ab | 7.6a | 320.4ab |
| 9 | 2199.3bc | 6.4a | 260.2bc |
| 10 | 2000.3c | 6.3a | 205.8bc |
| Control (100% wheat) | 2394.0cd | 6.8bd | 285.4ab |
| Saltines | 3135.4b | 11.5b | 324.2a |
| Munchems | 2781.0bc | 9.2c | 332.2a |
| Wheatables | 2167.0cd | 10.2bc | 181.4bc |
| Wheatsworth | 1870.8d | 8.6cd | 148.0c |
| Wheat Thins | 4108.3a | 18.7a | 386.4a |

^{a}Mean values in the same column for each group not followed by the same letter are significantly different (p ≦ 0.05). Texture measurements were made with an Instron universal testing machine (model 1122, Instron Corp., Canton, MA).
^{b}Formula numbers correspond to the numbers shown in Table 1.

### EXAMPLE V

### Composition

The proximate composition of crackers was determined. Moisture content was determined on 5 g ground samples by drying overnight at 70° C. under 25 mmHg. Ash content was determined on 2 g ground samples by heating overnight in a muffle furnace at 525° C. Dried samples remaining from moisture analysis were used for fat analysis. Fat analysis was determined by overnight solvent extraction (about 16-18 hr) with petroleum ether using a Goldfisch apparatus (Labconco, Kansas City, Mo.). Nitrogen content was determined on 0.2 g ground samples using the Dumas combustion method (LECO analyzer, model 602-600, Warrendale, Pa.). The proximate composition of five flavor variations of the most promising formulation was determined on a fresh weight basis (as consumed) by Silliker Laboratories, Stone Mountain, Ga.

The proximate composition of the illustrative crackers is shown in Table 5. Moisture content of the 10 peanut flour mixtures ranged from 4.29 to 7.38%; commercial crackers contained 5.45 to 12.81% moisture. Ash content was similar for all crackers, ranging from 3.12 to 4.27% in the illustrative formulas and from 2.10 to 4.49% in the commercial products. Crude fat content ranged from 15.79 to 19.54% in the illustrative products and from 9.21 to 18.8% in the commercial crackers. Among the 10 illustrative formulas, those having the highest amount of peanut flour, #3 (42%) and #10 (30.33%), had the highest nitrogen content (3.87 and 3.15%, respectively). Not surprisingly, all of the illustrative crackers contained more nitrogen (1.74 to 3.87%) and thus more protein than the commercial crackers (1.24 to 1.68% nitrogen) due to the inclusion of peanut as an ingredient.

TABLE 5
Proximate composition (wet basis) of peanut flour crackers and
selected commercial crackers^{a}

| | | | | % |
|---|---|---|---|---|
| Formula^{b} | % Moisture | % Ash | % Crude fat | Nitrogen |
| 1 | 7.37 | 3.28 | 15.79 | 1.75 |
| 2 | 5.15 | 3.12 | 15.89 | 1.75 |
| 3 | 4.29 | 4.27 | 19.54 | 3.87 |
| 4 | 7.38 | 3.32 | 15.94 | 1.74 |
| 5 | 6.88 | 3.84 | 17.31 | 2.74 |
| 6 | 6.33 | 3.83 | 17.64 | 2.77 |
| 7 | 6.23 | 3.55 | 17.15 | 2.47 |
| 8 | 6.12 | 3.36 | 16.64 | 2.15 |
| 9 | 6.00 | 3.44 | 16.65 | 2.10 |
| 10 | 5.54 | 3.90 | 18.77 | 3.15 |
| Control (100% wheat) | 5.67 | 3.06 | 15.67 | 1.38 |
| Saltines | 6.08 | 3.33 | 9.21 | 1.41 |
| Munchems | 12.42 | 2.38 | 11.62 | 1.33 |
| Wheatables | 5.45 | 2.10 | 17.64 | 1.24 |
| Wheatsworth | 11.95 | 4.49 | 18.80 | 1.68 |
| Wheat Thins | 12.81 | 2.91 | 9.23 | 1.59 |

^{a}Mean values in the same column for each group not followed by the same letter are significantly different (p ≦ 0.05).
^{b}Formula numbers correspond to the numbers shown in Table 1.

### EXAMPLE VI

### Sensory Attributes

A consumer acceptability test of five flavor variations of the most promising formulation (control, 1% salt; cheddar cheese, 10.5%; Cajun salt, 2.4%; cheddar cheese/cayenne pepper, 10.4%; garlic powder, 2.0%) of peanut flour crackers was conducted. Consumers (n=75) were recruited from the local community (Griffin, Ga.) and were screened to (1) be at least 18 years old, (2) eat crackers on a regular basis and (3) not be allergic to peanuts, wheat, milk, salt, rice, egg, garlic, cheese, or Cajun seasoning. Demographic characteristics of the participants were as follows: ages ranged from 18-75 with 24% being 55-64 years of age; 80% were female; 77% were white; 59% were married; 61% had completed high school, vocational school, or some college; 43% were employed full time; and 53% had incomes ≦$30,000.

Sensory evaluation was conducted in the climate-controlled sensory evaluation laboratory of the Department of Food Science and Technology, University of Georgia—Griffin Campus. When the panelists arrived, they completed a consent form and received instructions on the conduct of the evaluation. Panelists evaluated samples in partitioned booths illuminated with incandescent lighting, using a 9-point hedonic scale (1=dislike extremely, 5=neither like nor dislike, 9=like extremely). Samples coded with 3-digit numbers were presented monadically and in a randomized order. Panelists cleansed their palates between samples with water and unsalted crackers. After the evaluation, panelists completed an exit questionnaire pertaining to cracker purchasing, consumption and handling practices and their willingness to purchase nutrition-enhanced crackers.

The General Linear Model (GLM) procedure was used to analyze all data (SAS Institute, 2001). Mean separation tests were performed by the least significant difference (LSD) test (α=0.05).

All 10 illustrative formulas produced crackers with acceptable sensory attributes. The flour mixture with the highest level of peanut flour that also exhibited the best overall dough handling characteristics was formula #6 (58% wheat, 17.5% rice, 24.5% peanut). Therefore, formula #6 was used for further development to evaluate various seasonings for flavor enhancement. Hereafter, formula #6 is referred to as the control.

The mean ratings for consumer acceptance of the control and four flavor variations (cheddar cheese, Cajun salt, cheddar cheese and cayenne, and garlic powder) of crackers are shown in Table 6. Preliminary trials established the appropriate level of each seasoning; all samples were formulated to contain 1.0% salt. Crackers made with cheddar cheese or cheddar cheese/cayenne pepper received the highest ratings for appearance (7.0=like moderately), color (7.1-7.2), aroma (6.3-6.5=like slightly), flavor (6.4-6.5), texture (6.6-6.7) and overall liking (6.4-6.7). The control, which was flavored only with 1% salt, received the lowest rating for flavor (4.2=dislike slightly). The most frequent comments made about the control, garlic and cheddar cheese-flavored crackers were that they were bland and soft. Cajun-flavored crackers were described as soft, too salty, and having a lard taste. Some panelists described the cheddar cheese/cayenne pepper crackers as being too hot or too salty whereas an equal number considered them to be bland. These findings indicate that further research to improve the texture and flavor of these prototypes is needed.

TABLE 6
Mean ratings for consumer (n = 75) acceptance of peanut flour crackers¹

| | Sensory Attributes² | | | | | Overall |
|---|---|---|---|---|---|---|
| Seasoning | Appearance | Color | Aroma | Flavor | Texture | Liking² |
| Control (58% wheat, | 5.1c | 5.1c | 4.9b | 4.2c | 4.3b | 4.1b |
| 17.5% rice, 24.5% peanut) | | | | | | |
| Cheddar cheese (10.5%) | 7.0a | 7.1a | 6.5a | 6.5a | 6.6a | 6.4a |
| Cajun salt (2.4%) | 5.8b | 5.7b | 5.3b | 4.6bc | 4.7b | 4.7b |
| Cheddar cheese and | 7.0a | 7.2a | 6.3a | 6.4a | 6.7a | 6.7a |
| cayenne (10.4%) | | | | | | |
| Garlic powder (2.0%) | 5.5bc | 5.4bc | 5.3b | 4.9b | 4.8b | 4.6b |

¹Values in a column not followed by the same letter are significantly different at p ≦ 0.05. All samples contained ˜1.0% salt.
²On a nine-point scale, 1 = dislike extremely, 5 = neither like nor dislike, and 9 = like extremely.

Table 7 shows the cracker purchasing, consumption, handling and willingness-to-buy characteristics of consumers who participated in the sensory evaluation of the illustrative peanut flour crackers. Sixty percent of the panelists purchased crackers once a week, with 80% purchasing them in a box, rather than as multi-packs (16%) or as individual packages from a vending machine (4%). Saltines were the type of cracker purchased most often (48%) followed by cheese crackers (28%). Nearly half (47%) of the panelists consumed crackers on a weekly basis while 24% ate them daily. Texture (softness, hardness) was the primary characteristic used by panelists (84%) to decide if crackers were no longer edible, followed by flavor, i.e., staleness (76%). The attribute that was most important to consumers that influenced eating quality was flavor (99%) followed by texture (75%), appearance (53%) and aroma (49%). Two-thirds of the panelists were concerned about the nutritional quality of the crackers they consumed, and 71% were willing to pay more for crackers with enhanced nutritional quality.

TABLE 7
Cracker purchasing, consumption, handling, and willingness-to-buy characteristics
of consumers (n = 75) who participated in sensory evaluation of peanut flour
crackers, November 2004

| Questions | | Percentage |
|---|---|---|
| 1. | How often do you buy crackers? (n = 71) | |
| | Less than once a week | 32.4 |
| | Once a week | 60.6 |
| | Twice a week | 5.6 |
| | Three or more times a week | 1.4 |
| 2. | How often do you eat crackers? (n = 75) | |
| | Daily | 24.0 |
| | Weekly | 46.7 |
| | Monthly | 8.0 |
| | Occasionally | 21.3 |
| 3. | What type of crackers do you purchase most often? (n = 75) | |
| | Cheese | 28.0 |
| | Saltine | 48.0 |
| | Wheat Thins | 8.0 |
| | Wheat | 1.3 |
| | Whole Wheat Saltines | 2.7 |
| | Town House | 1.3 |
| | Triscuits | 1.3 |
| | Ritz | 5.3 |
| | Peanut Butter/Cheese | 1.3 |
| | Ginger Snaps | 1.3 |
| | Oyster | 1.3 |
| 4. | Which do you purchase most often? (n = 75) | |
| | Box | 80.0 |
| | Pack (multi pack) | 16.0 |
| | Pack (vending machine) | 4.0 |
| 5. | Are you concerned about the nutritional quality of your crackers? (n = 73) | |
| | Yes | 67.1 |
| | No | 32.9 |
| 6. | After opening, how long do you keep your boxed crackers before | |
| | they go stale? (n = 74) | |
| | 1 week or less | 20.3 |
| | Less than 2 weeks | 21.6 |
| | Less than 1 month | 33.8 |
| | More than 1 month | 24.3 |
| 7. | How do you decide if your crackers are no longer edible? (n = 75) | |
| | Appearance (mold, color, etc.) | 44.0 |
| | Texture (too soft, too hard, etc.) | 84.0 |
| | Flavor (stale) | 76.0 |
| | Length of storage | 37.3 |
| | Other (expiration date, aroma) | 4.0 |
| 8. | When you eat crackers, what attributes are important to you? (n = 75) | |
| | Appearance | 53.3 |
| | Aroma | 49.3 |
| | Flavor | 98.7 |
| | Texture (mouthfeel) | 74.7 |
| | Other (spice) | 2.7 |
| 9. | Would you be willing to pay more for crackers with higher nutritional | |
| | quality? (n = 73) | |
| | Yes | 71.2 |
| | No | 28.8 |
| 10. | If yes, check how much more per package: (n = 51) | |
| | 5-10 cents | 37.3 |
| | 11-15 cents | 13.7 |
| | 16-20 cents | 13.7 |
| | 21-25 cents | 15.7 |
| | more than 25 cents | 19.6 |

The proximate composition of various flavors of peanut flour crackers was determined by Silliker Laboratories, Stone Mountain, Ga. and is shown in Table 8. Although the seasoning level varied in each formula, proximate composition was not significantly affected by the type of seasoning.

TABLE 8
Proximate composition of illustrative peanut flour crackers.¹

| | % | % | % | | |
|---|---|---|---|---|---|
| Sample | Ash² | Fat³ | Moisture⁴ | % Protein⁵ | Carbohydrate⁶ |
| Control (1.0% | 3.07 | 18.47 | 7.43 | 14.40 | 56.63 |
| salt) | | | | | |
| Garlic powder | 3.04 | 17.29 | 7.56 | 14.90 | 57.21 |
| (2.0%) | | | | | |
| Cajun salt (2.4%) | 3.88 | 16.96 | 7.03 | 15.67 | 56.46 |
| Cheddar cheese | 5.14 | 19.11 | 5.01 | 14.56 | 56.18 |
| (10.5%) | | | | | |
| Cheddar cheese | 5.11 | 19.86 | 5.19 | 14.11 | 55.73 |
| and Cayenne | | | | | |
| (10.4%) | | | | | |

¹Analysis performed on fresh weight basis (as consumed)
²AOAC Method 923.03
³Acid Hydrolysis Mojonnier, AOAC Method 935.38
⁴Vacuum oven, AOAC Method 925.09
⁵Protein, kjeldahl, AOAC Method, 991.20.1, conversion factor = 5.46
⁶By difference

Although the invention has been described in detail with reference to preferred embodiments, variations and modifications exist within the scope and spirit of the invention as described and defined in the following claims.

1. A baked food product comprising:
a flour mixture comprising peanut flour,
baking powder,
a fat,
a milk product, and
egg.

2. The baked food product of claim 1 wherein the peanut flour is a light roast peanut flour.

3. The baked food product of claim 2 wherein the peanut flour is partially defatted and has between 10 and 14% fat.

4. The baked food product of claim 2 wherein the peanut flour has about 12% fat.

5. The baked food product of claim 1 wherein the peanut flour is between about 7 and about 42% of the composition, by weight.

6. The baked food product of claim 1 wherein the flour mixture further comprises wheat flour.

7. The baked food product of claim 6 wherein the flour mixture further comprises rice flour.

8. The baked food product of claim 1 wherein the flour mixture comprises between 55-95% wheat flour, between 0-35% rice flour, and between 7-45% peanut flour, by weight.

9. The baked food product of claim 8 wherein the flour mixture comprises about 58% wheat flour, about 17.5% rice flour, and about 24.5% peanut flour.

10. The baked food product of claim 1 wherein the milk product is selected from the group consisting of whole milk, reduced fat milk, and non-fat dry milk.

11. The baked food product of claim 1 wherein the fat is selected from the group consisting of butter, margarine, vegetable oil, hydrogenated vegetable oil, partially hydrogenated vegetable oil, and vegetable shortening.

12. The baked food product of claim 1 wherein the baked food product has a shape and texture of a cracker.

13. The baked food product of claim 1, further comprising a seasoning.

14. The baked food product of claim 13 wherein the seasoning is selected from the group consisting of Cajun seasoning, garlic seasoning, cheddar cheese seasoning, herbal seasoning, cayenne seasoning, and mixtures thereof.

15. The baked food product of claim 1 having a degree of lightness between 70 and 80, a degree of redness between 2.0 and 6.5, and a degree of yellowness between 27 and 34.

16. The baked food product of claim 1 having a force value of between 1800 and 3000 N.

17. The baked food product of claim 1 wherein
the flour mixture comprises 56-58% of a mixture and comprises 56-60% all purpose wheat flour, 16-18% rice flour; and 22-26% peanut flour (12% fat, light roast),
the baking powder comprises up to 1% of the mixture,
the fat is partially hydrogenated vegetable oil and comprises 10-12% of the mixture,
the milk product comprises 23-27% of the mixture and comprises non-fat dry milk and water,
the egg comprises 3-5% of the mixture,
and further comprising Cajun seasoning, the seasoning comprising up to 3% of the mixture.

18. A method of preparing a baked food product comprising:
preparing a dough comprising wheat flour, salt, baking powder, a fat, a milk product, egg, and peanut flour,
rolling the dough, and
baking the dough.

19. The method of claim 18, further comprising the step of cutting the dough into cracker size, prior to the baking step.

20. The method of claim 18 wherein the baking step includes baking in an impingement oven.

21. The method of claim 18 wherein the baking step includes baking at 200° C.

22. The method of claim 18 wherein the baking step includes baking for a sufficient time period to obtain a generally uniform crispy texture.

23. A baked food product according to the method of claim 18.
